(19) United States
(12) Patent Application Publication
(10) Pub. No.: US 2021/0090117 A1
(43) Pub. Date: Mar. 25, 2021

(54) OFFER PLATFORM SERVER AND CLIENT DEVICES

(71) Applicant: Viral Launch, Inc., Indianapolis, IN (US)

(72) Inventor: Casey Gauss, Indianapolis, IN (US)

(21) Appl. No.: 17/027,083

(22) Filed: Sep. 21, 2020

Related U.S. Application Data
(60) Provisional application No. 62/905,938, filed on Sep. 25, 2019.
(60) Provisional application No. 62/907,098, filed on Sep. 27, 2019.

(51) Int. Cl. G06Q 30/02

(52) U.S. Cl. CPC G06Q 30/0246; G06Q 30/0633; G06Q 30/0277

(57) ABSTRACT

Technologies for providing targeted offers including an offer platform server, multiple buyer devices and multiple seller devices. Each buyer device and seller device installs a web browser extension that communicates with the offer platform server. Seller devices create offers with the offer platform server. Each offer is associated with an offered product listed on a marketplace server and an offer value, and may include dynamic offer parameters. Buyer devices monitor user interactions with the marketplace server and communicate interaction data with the offer platform server. The offer platform server identifies matching offers and sends those offers to the buyer devices. The browser extension of the buyer device presents those offers to the user, for example by highlighting products or displaying products that are not in the search results. The offer platform server may apply offers selected by the user. Other embodiments are described and claimed.

### CROSS-REFERENCE TO RELATED APPLICATIONS

This application claims priority under 35 U.S.C. § 119(e) to U.S. Provisional Patent Application No. 62/905,938, which was filed on Sep. 25, 2019, and to U.S. Provisional Patent Application No. 62/907,098, which was filed on Sep. 27, 2019.

### BACKGROUND

Typical e-commerce platforms include large marketplace websites such as those hosted by Amazon™ or Walmart®. In those marketplaces, sellers may list products for sale, and buyers may access those products, for example through a keyword search. Typically, most sales occur for products that appear higher in search results, for example in the first page of search results.

### SUMMARY

According to one aspect of the disclosure, a computing device may include a browser extension, a user interaction manager, and an offer platform interface. The browser extension is associated with a web browser of the computing device. The user interaction manager is to (i) monitor, by the browser extension, a user interaction with a marketplace server by the web browser and (ii) determine, by the browser extension, interaction data indicative of the user interaction in response to monitoring of the user interaction. The offer platform interface is to (i) send, by the browser extension, the interaction data to an offer platform server in response to the monitoring of the user interaction and (ii) receive, by the browser extension, offer data from the offer platform server in response to sending of the interaction data, wherein the offer data is indicative of an offered product and an offer value. The user interaction manager is further to present, by the browser extension, an offer based on the offer data with the web browser.

In an embodiment, to monitor the user interaction may include to parse a uniform resource locator associated with the user interaction, wherein the uniform resource locator is provided by the web browser. In an embodiment, to monitor the user interaction may include to identify a keyword search. In an embodiment, to monitor the user interaction may include to identify a product details view. In an embodiment, to monitor the user interaction may include to identify a shopping cart check out.

In an embodiment, to present the offer may include to display a notification in a content area of the web browser. In an embodiment, to present the offer may include to highlight a search result corresponding to the offered product of the offer in a search results page presented by the web browser. In an embodiment, to present the offer may include to display product information corresponding to the offered product of the offer in a content area of the web browser.

According to another aspect, a method may include monitoring, by a browser extension of a computing device, a user interaction with a marketplace server by a web browser of the computing device; determining, by the browser extension, interaction data indicative of the user interaction in response to monitoring the user interaction; sending, by the browser extension, the interaction data to an offer platform server in response to monitoring the user interaction; receiving, by the browser extension, offer data from the offer platform server in response to sending the interaction data, wherein the offer data is indicative of an offered product and an offer value; and presenting, by the browser extension, an offer based on the offer data with the web browser.

In an embodiment, monitoring the user interaction may include parsing a uniform resource locator associated with the user interaction, wherein the uniform resource locator is provided by the web browser. In an embodiment, monitoring the user interaction may include identifying a keyword search. In an embodiment, monitoring the user interaction may include identifying a product details view. In an embodiment, monitoring the user interaction may include identifying a shopping cart check out.

In an embodiment, presenting the offer may include displaying a notification in a content area of the web browser. In an embodiment, presenting the offer may include highlighting a search result corresponding to the offered product of the offer in a search results page presented by the web browser. In an embodiment, presenting the offer may include displaying product information corresponding to the offered product of the offer in a content area of the web browser.

According to another aspect, a computing device may include a buyer interface and an offer manager. The buyer interface is to receive interaction data indicative of a user interaction with a marketplace server from a buyer computing device. The offer manager is to match the interaction data with an offer selected from a plurality of offers stored by the computing device, wherein each offer is indicative of an offered product and an offer value. The buyer interface is further to send offer data indicative of the offer to the buyer computing device in response to a match of the interaction data with the offer.

In an embodiment, to receive the interaction data may include to receive a search keyword; and to match the interaction data with the offer may include to match the search keyword with a keyword associated with the offer. In an embodiment, to receive the interaction data may include receiving a product identifier; and to match the interaction data with the offer may include to match the product identifier with a related product associated with the offer.

In an embodiment, to match the interaction data with the offer may include to match a buyer tier associated with the buyer computing device with a buyer tier associated with the offer, wherein to match the buyer tier comprises to determine the offer value based on the buyer tier.

In an embodiment, to receive the interaction data may include to receive an order identifier; and to match the interaction data with the offer may include to match a product associated with the order identifier with a related product associated with the offer.

In an embodiment, the buyer interface is further to receive a selection of the offer from the buyer computing device in response to sending of the offer data; and the offer manager is further to apply the offer to an order in response to receipt of the selection. In an embodiment, to apply the offer may include to generate a discount code for a marketplace server. In an embodiment, to apply the offer may include to perform a rebate process, wherein to perform the rebate process may include to: determine an order identifier associated with the order; monitor the order identifier with a marketplace server; determine whether the order is valid in response to monitoring of the order identifier; and apply the offer value of the offer in response to a determination that the order is valid.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for providing targeted offers to buyers using an offer platform server;

FIG. 2 is a simplified block diagram of various environments that may be established by the system of FIG. 1;

FIG. 3 is a simplified flow diagram of at least one embodiment of a method for accessing targeted offers that may be executed by a buyer computing device of FIGS. 1 and 2;

FIG. 4 is a simplified flow diagram of at least one embodiment of a method for creating targeted offers that may be executed by a seller computing device of FIGS. 1 and 2;

FIG. 5 is a simplified flow diagram of at least one embodiment of a method for managing targeted offers that may be executed by an offer platform server of FIGS. 1 and 2;

FIG. 6 is a simplified flow diagram of at least one embodiment of a method for automatic rebate fulfilment that may be executed by the offer platform server of FIGS. 1 and 2;

FIG. 7 is a schematic diagram of at least one embodiment of a web browser and browser extension interface of the buyer computing device of FIGS. 1-2;

FIG. 8 is a schematic diagram of at least one embodiment of a notification interface of the buyer computing device of FIGS. 1-2;

FIG. 9 is a schematic diagram of at least one embodiment of another notification interface of the buyer computing device of FIGS. 1-2; and

FIG. 10 is a schematic diagram of at least one embodiment of a related offers interface of the buyer computing device of FIGS. 1-2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

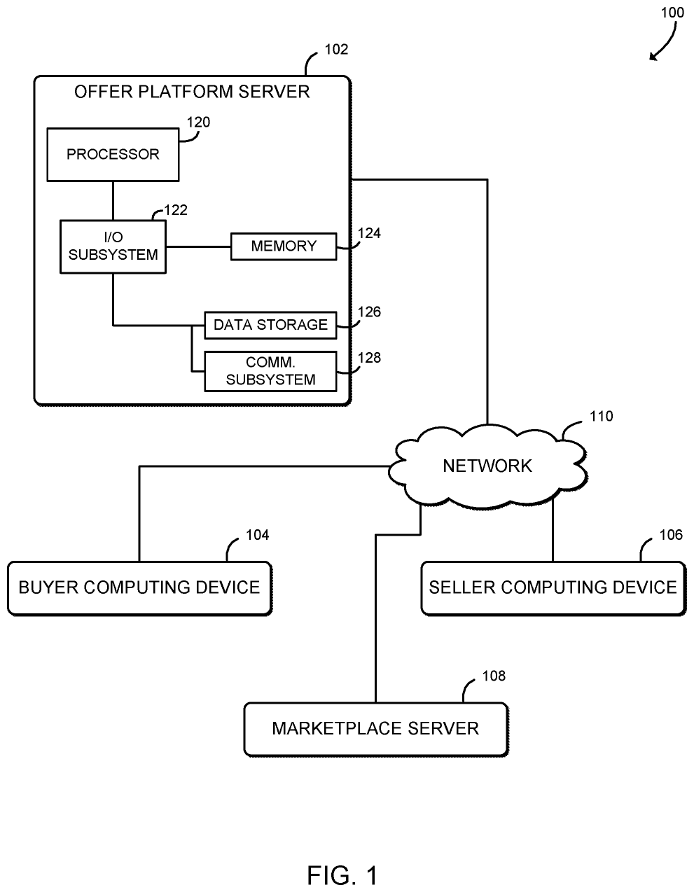

Referring now to FIG. 1, an illustrative system 100 for providing targeted offers to buyers includes an offer platform server 102, multiple buyer computing devices 104 and seller computing devices 106, and a marketplace server 108 in communication over a network 110. In use, the offer platform server 102 maintains a database of offers associated with products listed for sale with the marketplace server 108. For example, the offers may include percentage discounts, rebates, or other offers configured by the seller computing devices 106. Each of the buyer computing devices 104 monitors user interactions with the marketplace server 108 and sends interaction data to the offer platform server 102, and the offer platform server 102 matches the interaction data against available offers, which are in turn presented to the user by the buyer computing device 106. Thus, the system 100 may improve user experience for buyers using e-commerce platforms, for example by surfacing offers and/or products that are not currently displayed by the marketplace user interface. Additionally, the system 100 may provide an improved sales experience for sellers using e-commerce platforms by providing automated, dynamic offers capable of targeting particular users and/or user behavior.

The offer platform server 102 may be embodied as any type of device capable of performing the functions described herein. For example, the offer platform server 102 may be embodied as, without limitation, a server, a rack-mounted server, a blade server, a workstation, a network appliance, a web appliance, a desktop computer, a laptop computer, a tablet computer, a smartphone, a consumer electronic device, a distributed computing system, a multiprocessor system, and/or any other computing device capable of performing the functions described herein. Additionally, in some embodiments, the offer platform server 102 may be embodied as a “virtual server” formed from multiple computing devices distributed across the network 110 and operating in a public or private cloud. Accordingly, although the offer platform server 102 is illustrated in FIG. 1 as embodied as a single computing device, it should be appreciated that the offer platform server 102 may be embodied as multiple devices cooperating together to facilitate the functionality described below. As shown in FIG. 1, the illustrative offer platform server 102 includes a processor 120, an I/O subsystem 122, memory 124, a data storage device 126, and communication circuitry 128. Of course, the offer platform server 102 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor or compute engine capable of performing the functions described herein. For example, the processor may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the offer platform server 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the offer platform server 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the offer platform server 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication circuitry 128 of the offer platform server 102 may be embodied as any communication circuit, device, or collection thereof, capable of enabling communications between the offer platform server 102, the buyer computing device 104, the seller computing device 108, the marketplace server 108, and/or other remote devices. The communication circuitry 128 may be configured to use any one or more communication technology (e.g., wireless or wired communications) and associated protocols (e.g., Ethernet, Bluetooth®, Wi-Fi®, WiMAX, etc.) to effect such communication.

Each buyer computing device 104 and seller computing device 106 is configured to access the offer platform server 102 and otherwise perform the functions described herein. Each of the buyer computing device 104 and the seller computing device 106 may be embodied as any type of computation or computer device capable of performing the functions described herein, including, without limitation, a computer, a laptop computer, a notebook computer, a tablet computer, a mobile computing device, a wearable computing device, a multiprocessor system, a server, a rack-mounted server, a blade server, a network appliance, a web appliance, a distributed computing system, a processor-based system, and/or a consumer electronic device. Thus, each of the buyer computing device 104 and the seller computing device 106 includes components and devices commonly found in a computer or similar computing device, such as a processor, an I/O subsystem, a memory, a data storage device, and/or communication circuitry. Those individual components of the buyer computing device 104 and the seller computing device 106 may be similar to the corresponding components of the offer platform server 102, the description of which is applicable to the corresponding components of the buyer computing device 104 and the seller computing device 106 and is not repeated herein so as not to obscure the present disclosure.

Similarly, the marketplace server 108 may be embodied as any type of computation or computer device capable of performing the functions described herein, including, without limitation, a server, a rack-mounted server, a blade server, a workstation, a network appliance, a web appliance, a desktop computer, a laptop computer, a tablet computer, a smartphone, a consumer electronic device, a distributed computing system, a multiprocessor system, and/or any other computing device capable of performing the functions described herein. Thus, the marketplace server 108 includes components and devices commonly found in a computer or similar computing device, similar to the corresponding components of the offer platform server 102, the description of which is not repeated herein so as not to obscure the present disclosure. Additionally, in some embodiments, the marketplace server 108 may be embodied as a “virtual server” formed from multiple computing devices distributed across the network 110 and operating in a public or private cloud.

As discussed in more detail below, the offer platform server 102, the buyer computing device 104, the seller computing device 106, and the marketplace server 108 may be configured to transmit and receive data with each other and/or other devices of the system 100 over the network 110. The network 110 may be embodied as any number of various wired and/or wireless networks. For example, the network 110 may be embodied as, or otherwise include, a wired or wireless local area network (LAN), a wired or wireless wide area network (WAN), and/or a publicly-accessible, global network such as the Internet. As such, the network 110 may include any number of additional devices, such as additional computers, routers, and switches, to facilitate communications among the devices of the system 100.

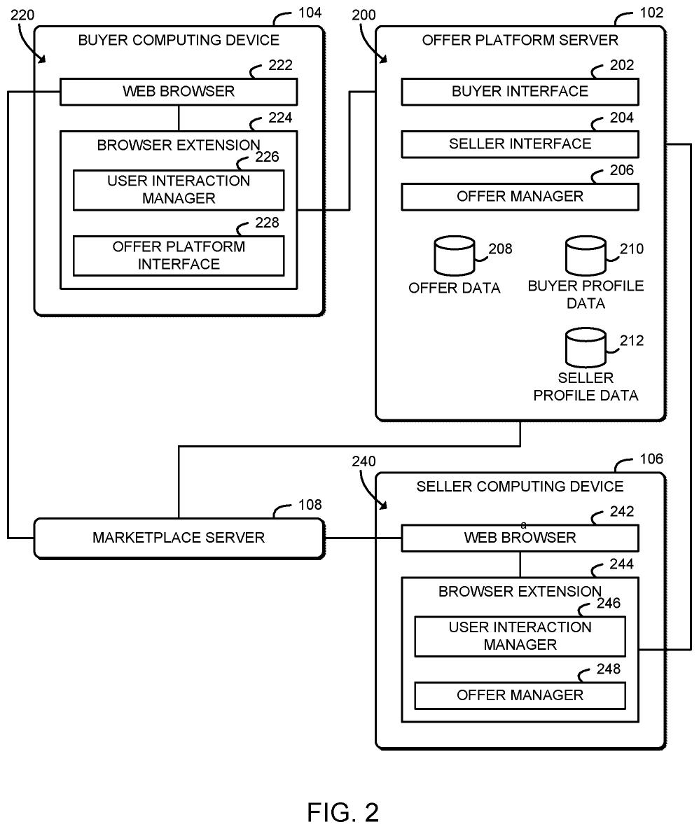

Referring now to FIG. 2, in the illustrative embodiment, the offer platform server 102 establishes an environment 200 during operation. The illustrative environment 200 includes a buyer interface 202, a seller interface 204, and an offer manager 206. The various components of the environment 200 may be embodied as hardware, firmware, software, or a combination thereof. As such, in some embodiments, one or more of the components of the environment 200 may be embodied as circuitry or a collection of electrical devices (e.g., buyer interface circuitry 202, seller interface circuitry 204, and/or offer manager circuitry 206). It should be appreciated that, in such embodiments, one or more of those components may form a portion of the processor 120, the I/O subsystem 122, and/or other components of the offer platform server 102.

The seller interface 204 is configured to create an offer associated with an offered product listed for sale with the marketplace server 108 by the seller computing device 106. The offer is indicative of the offered product and an offer value. Created offers may be stored in offer data 208 maintained by the offer platform server 102. Creating the offer may include selecting the offer value and a total number of offers that are available. Creating the offer may include configuring one or more dynamic parameters associated with the offer, such as search keywords, related products, or buyer tiers. The seller interface 204 may be configured to update seller profile data 212 associated with the offer in response to a buyer selecting the offer and successful application of the offer.

The buyer interface 202 is configured to receive interaction data from a buyer computing device 104. The interaction data is indicative of a user interaction performed by the buyer computing device 104 with the marketplace server 108, and may be received from a browser extension of the buyer computing device 104. The interaction data may include a search keyword, a product identifier, or an order identifier. The buyer interface 202 is further configured to send offer data indicative of a matching offer to the buyer computing device 104 in response to matching the interaction data with the offer as described below. The buyer interface 202 is further configured to receive a selection of the offer from the buyer computing device 104 in response to sending the offer data. The buyer interface 202 may be further configured to update a buyer tier associated with the buyer computing device in response to selecting of the offer. The buyer tier may be stored in buyer profile data 210 maintained by the offer platform server 102.

The offer manager 206 is configured to match the interaction data with an offer selected from the offer data 208 stored by the offer platform server 102. Matching the interaction data may include matching the search keyword received from the buyer computing device 104 with a keyword associated with the offer, matching the product identifier received from the buyer computing device 104 with a related product associated with the offer, or matching a product associated with the order identifier received from the buyer computing device 104 with a related product associated with the offer. In some embodiments, matching the interaction data with the offer may include matching a buyer tier associated with the buyer computing device 104 with a buyer tier associated with the offer. Matching the buyer tier may include determining the offer value based on the buyer tier. The offer manager 206 is further configured to apply the offer to an order in response to receiving a selection of the offer from the buyer computing device 104. Applying the offer may include generating a discount code for the marketplace server 108 or performing a rebate process. Performing the rebate process may include monitoring an order identifier associated with the order to determine whether the order is valid, and applying the offer value of the offer if the order is valid.

Still referring to FIG. 2, in the illustrative embodiment, the buyer computing device 104 establishes an environment 220 during operation. The illustrative environment 220 includes a web browser 222 and a browser extension 224. The browser extension 224 further includes a user interaction manager 226 and an offer platform interface 228. The various components of the environment 220 may be embodied as hardware, firmware, software, or a combination thereof. As such, in some embodiments, one or more of the components of the environment 220 may be embodied as circuitry or a collection of electrical devices (e.g., user interaction manager circuitry 226 and/or an offer platform interface circuitry 228). It should be appreciated that, in such embodiments, one or more of those components may form a portion of the processor, the I/O subsystem, and/or other components of the buyer computing device 104.

The web browser 222 may be embodied as an interactive application for interacting with web servers or other remote hosts. The web browser 222 may provide a content area in which HTML or other web content is rendered or otherwise displayed. A user may interact with the web browser 222 through the content area as well as one or more other user interface controls such as menus, toolbars, icons, and other controls. The web browser 222 further includes an extensibility system by which one or more browser extensions, plugins, or other code modules may be loaded and executed in cooperation with the web browser 222. Illustratively, the web browser 222 is embodied as Google® Chrome™; however, in other embodiments the web browser 222 may be embodied as Mozilla® Firefox®, Apple® Safari®, Microsoft Edge®, or any other web browser.

The browser extension 224 may be embodied as an extension, plugin, executable, or other code module that may be loaded and executed in cooperation with the web browser 222. As shown, the browser extension 224 includes or otherwise establishes the user interaction manager 226 and the offer platform interface 228. Additionally, although illustrated as being part of an extensible system that includes the web browser 222 and the browser extension 224, it should be understood that in some embodiments the functions of those components may be performed by a monolithic web browser, an application, or any other program executed by the buyer computing device 104.

The user interaction manager 226 is configured to monitor a user interaction performed by the web browser 222 with the marketplace server 208, and to determine interaction data indicative of the user interaction. The user interaction may result from one or more operations performed by a user of the buyer computing device 104. The user interaction may be monitored by parsing a uniform resource locator provided by the web browser 222 that is associated with the user interaction. Monitoring the user interaction may include identifying a keyword search, identifying a product details view, or identifying a shopping cart check out. Similarly, determining the interaction data may include extracting one or more search keywords based on the keyword search, extracting a product identifier based on the product details, or extracting an order identifier based on the shopping cart check out. The user interaction manager 226 is further configured to present an offer with the web browser 222 based on offer data received from the offer platform server 102. The offer data is indicative of an offered product and an offer value. Presenting the offer may include displaying a notification in the content area of the web browser 22, highlighting a search result corresponding to the offer in a search results page presented by the web browser 222, or displaying product information corresponding to the offer in the content area of the web browser 222. The product information may be associated with a related product displayed in the content area of the web browser 222. In some embodiments, multiple offers may be displayed in the content area of the web browser 222. The user interaction manager 226 is further configured to receive a selection of the offer from the user and to apply the selected offer to an order. Applying the offer may include to applying a discount code with the marketplace server 108 or initiating a rebate process with the offer platform server 102.

The offer platform interface 228 is configured to send the interaction data to the offer platform server 102 in response to monitoring the user interaction. As described above, the offer platform server 102 identifies one or more matching offers for the interaction data. The offer platform interface 228 is further configured to receive the offer data from the offer platform server 102 in response to sending the interaction data.

Still referring to FIG. 2, in the illustrative embodiment, the seller computing device 106 establishes an environment 240 during operation. The illustrative environment 240 includes a web browser 242 and a browser extension 244. The browser extension 244 further includes a user interaction manager 246 and an offer manager 248. The various components of the environment 240 may be embodied as hardware, firmware, software, or a combination thereof. As such, in some embodiments, one or more of the components of the environment 240 may be embodied as circuitry or a collection of electrical devices (e.g., user interaction manager circuitry 246 and/or an offer manager circuitry 248). It should be appreciated that, in such embodiments, one or more of those components may form a portion of the processor, the I/O subsystem, and/or other components of the seller computing device 106.

The web browser 242 and the browser extension 244 are similar to the web browser 222 and the browser extension 224 of the buyer computing device 104, the description of which is applicable to the corresponding components of the seller computing device 106 and is not repeated herein so as not to obscure the present disclosure. As shown, the browser extension 244 of the seller computing device 106 includes or otherwise establishes the user interaction manager 246 and the offer manager 248. Additionally, although illustrated as being part of an extensible system that includes the web browser 242 and the browser extension 244, it should be understood that in some embodiments the functions of those components may be performed by a monolithic web browser, an application, or any other program executed by the seller computing device 106.

The user interaction manager 246 is configured to monitor a user interaction performed by the web browser 242 with the marketplace server 208. The user interaction manager 246 is further configured to determine interaction data indicative of the user interaction. The interaction data includes an offered product listed for sale.

The offer manager 248 is configured to create an offer for the offered product with the offer platform server 102. The offer is indicative of the offered product and an offer value. Creating the offer may include selecting the offer amount and a total number of offers. Creating the offer may also include configuring one or more dynamic parameters of the offer, such as search keywords, related products, or buyer tiers.

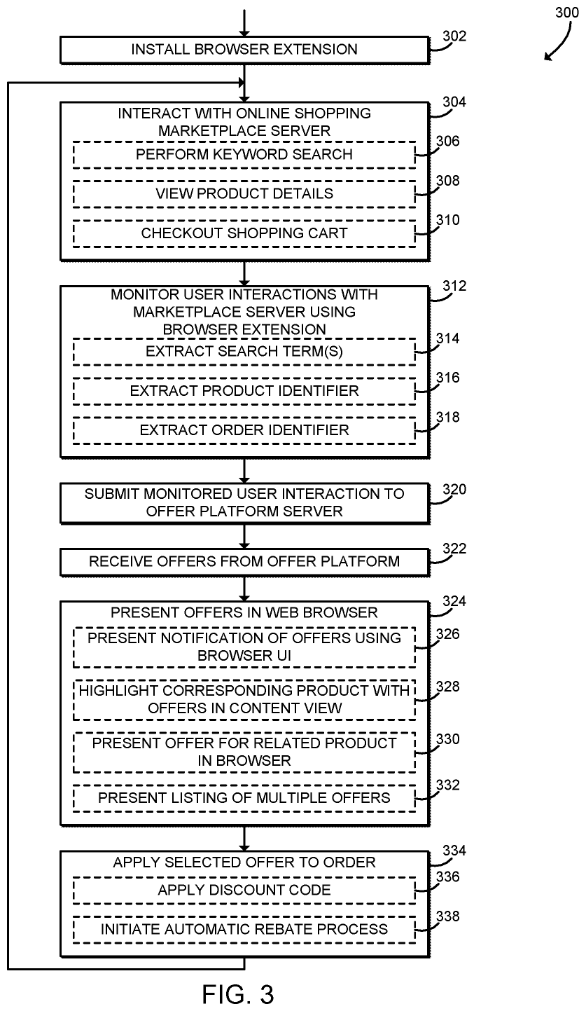

Referring now to FIG. 3, in use, a buyer computing device 104 may execute a method 300 for accessing targeted offers. It should be appreciated that, in some embodiments, the operations of the method 300 may be performed by one or more components of the environment 220 of the buyer computing device 104 as shown in FIG. 2. The method 300 begins with block 302, in which the buyer computing device 104 installs the browser extension 224. The browser extension 224 may be installed using an extensibility mechanism of the web browser 222. In some embodiments, installation of the browser extension 224 may be user-initiated, and thus the user may grant permissions or otherwise approve installation of the browser extension 224. In some embodiments, the browser extension 224 may be downloaded from the offer platform server 102 or another web server.

In block 304, the buyer computing device 104 interacts with the online shopping marketplace server 108. The interaction may be performed by the web browser 222, for example by performing one or more page loads or other web requests to the marketplace server 108. In some embodiments, in block 306 the buyer computing device 104 may perform a keyword search. In some embodiments, in block 308 the buyer computing device 104 may view product details. For example, the buyer computing device 104 may view details of one or more products displayed in a search results page. In some embodiments, in block 310 the buyer computing device 104 may checkout or otherwise view a shopping cart. The shopping cart may include one or more products that have or will be purchased by the user.

In block 312, the buyer computing device 104 monitors the user interactions with the marketplace server 108 using the browser extension 224. The browser extension 224 may use any technique to monitor user selections, requests, or other interactions with the marketplace server 108. The browser extension 224 may, for example, parse the current uniform resource locator (URL) being accessed by the web browser 222 or otherwise monitor operations of the web browser 222. Additionally or alternatively, in some embodiments the browser extension 224 may provide the URL to the offer platform server 102 for processing. In some embodiments, in block 314 the browser extension 224 may extract one or more search terms or other keywords. The keywords may be extracted from the current URL, from one or more user input controls, or otherwise extracted by the browser extension 224. Additionally or alternatively, in some embodiments, the browser extension 224 may extract one or more search filters, search categories, or other search parameters. In some embodiments, in block 316 the browser extension 224 may extract a product identifier. The product identifier may be associated with a current product detail view or other product displayed in the web browser 222. In some embodiments, in block 318 the browser extension 224 may extract an order identifier. The order identifier may be associated with a completed or pending order, for example an order displayed in a shopping cart view.

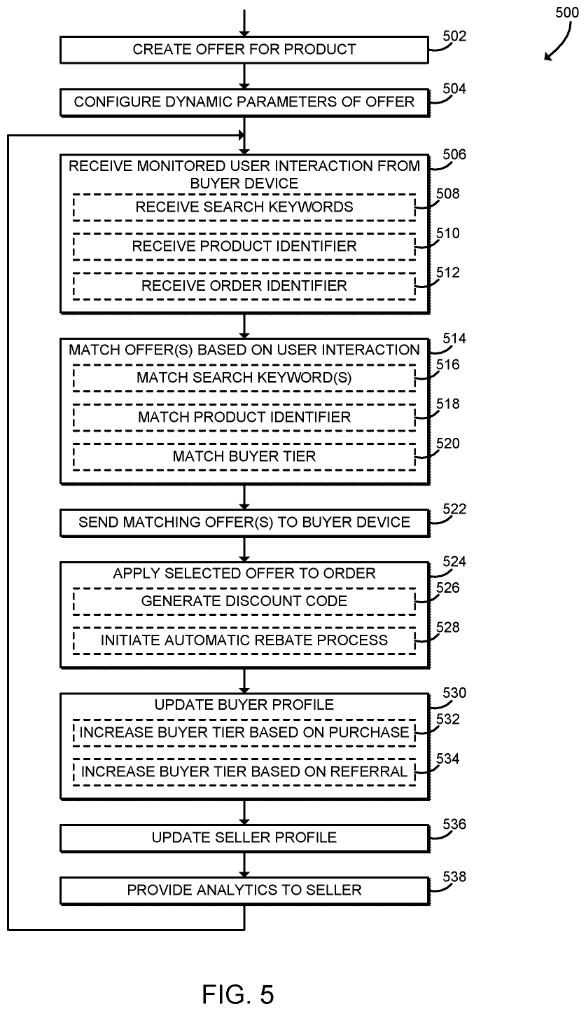

In block 320, the buyer computing device 104 submits the monitored user interaction to the offer platform server 102. The buyer computing device 104 may, for example, submit interaction data indicative of the user interaction (e.g., keywords, product identifiers, order identifiers, or other interaction data) to the offer platform server 102. As described below in connection with FIG. 5, the offer platform server 102 uses the interaction data to identify one or more matching offers.

In block 322, the buyer computing device 104 receives one or more offers from the offer platform server 102. Each offer is associated with a product listed for sale on the marketplace server 108 and an offer value. Each offer may be embodied as a discount offer, a rebate offer, or other offer provided by the seller of the associated product. Further, each offer may include a discount amount, a rebate amount, or other offer value, which may be expressed as a monetary value, a percentage, or other value.

In block 324, the buyer computing device 104 presents the received offers in the web browser 222. In particular, the browser extension 224 may present the offers in the content area of the web browser 222 (e.g., by modifying or overlaying existing web content) or may present the offers using one or more user interface controls of the web browser 222 (e.g., toolbar buttons).

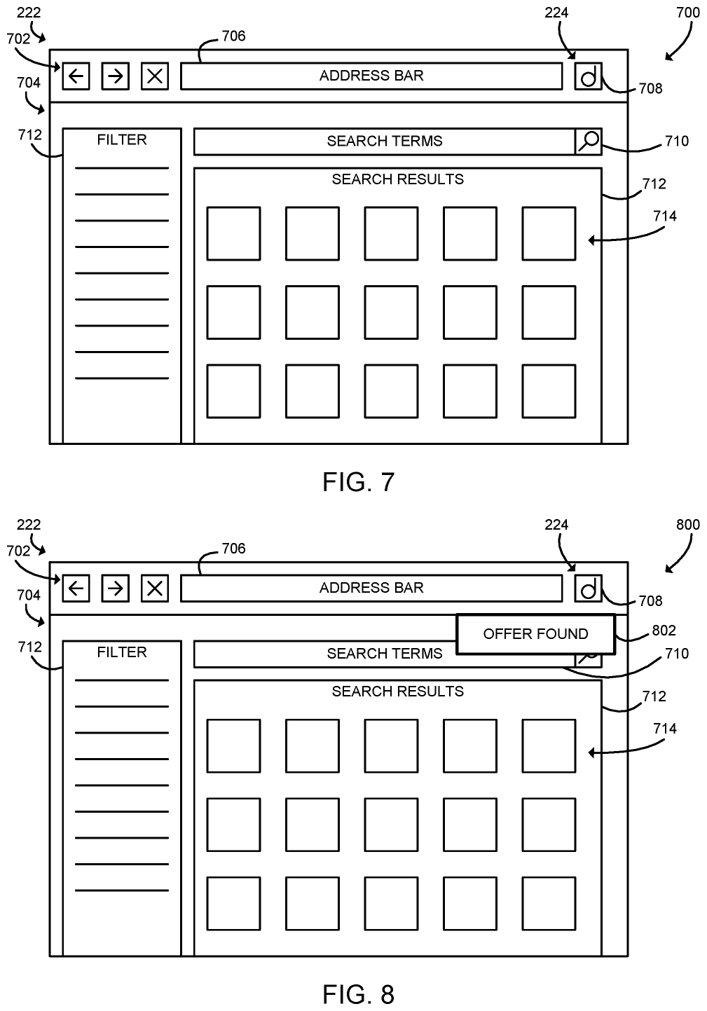

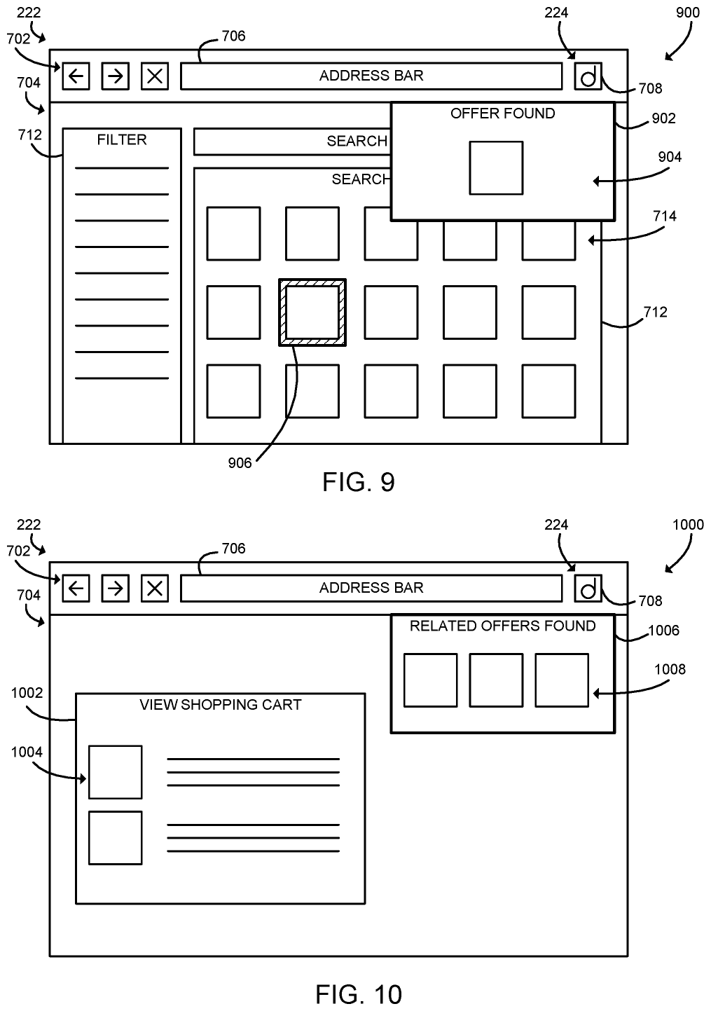

In some embodiments, in block 326 the browser extension 224 presents a notification of the matching offer using the web browser 222. The notification may be presented using a user interface control or as an overlay of the content area. For example, the browser extension 224 may present a notification for a matching offer for a product that is not visible in a current page of search results. One potential embodiment of a user interface for presenting such a notification is described below in connection with FIGS. 7 and 8. In some embodiments, in block 328 the browser extension 224 may highlight a product corresponding to the offer that is currently displayed in the content area. For example, the browser extensions 224 may highlight the product within the current page of search results. One potential embodiment of a user interface for presenting an offer with highlighted search results is described below in connection with FIG. 9. In some embodiments, in block 330 the browser extension 224 may present an offer for a related product in the web browser 222. For example, the offer may be for a product that is related to the product shown in a detail view or to a product that is in a shopping cart view. One potential embodiment of a user interface for presenting related offers is described below in connection with FIG. 10. In some embodiments, in block 332 the browser extension 224 may present a listing of multiple offers. For example, the browser extension 224 may present a catalog, a directory, a portal, or other listing of offers available on the offer platform server 102. In some embodiments, the browser extension 224 and/or the web browser 222 may present a standalone website or other interface that allows the user to browse, search, or otherwise access all offers available on the offer platform server 102, without requiring separate interactions with the marketplace server 108.

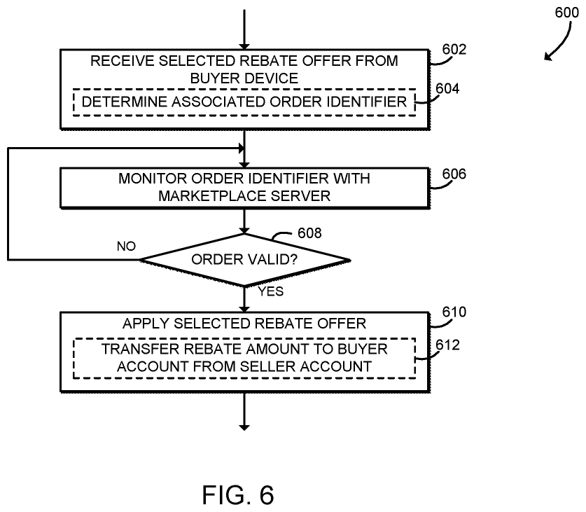

In block 334, the buyer computing device 104 applies a selected offer to an order. The browser extension 224 may receive a selection of the selected offer from the user, for example in response to the user clicking on a link or other user interface control in the web browser 222 and/or browser extension 224. In some embodiments, in block 336 the buyer computing device 104 may apply a discount code with the marketplace server 108 to the order. As described further below, the discount code may be generated by the offer platform server 102. In some embodiments, in block 338 the buyer computing device 104 may initiate an automatic rebate process with the offer platform server 102. One potential embodiment of the automatic rebate process is described below in connection with FIG. 6. After applying the selected offer, the method 300 loops back to block 304 to continue monitoring user interactions and presenting matching offers.

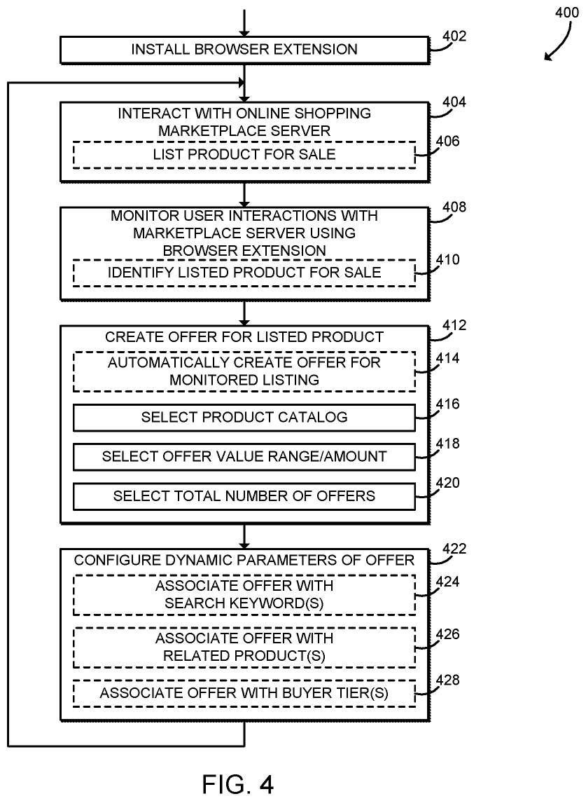

Referring now to FIG. 4, in use, a seller computing device 106 may execute a method 400 for creating targeted offers. It should be appreciated that, in some embodiments, the operations of the method 400 may be performed by one or more components of the environment 240 of the seller computing device 106 as shown in FIG. 2. The method 400 begins with block 402, in which the seller computing device 106 installs the browser extension 244. The browser extension 244 may be installed using an extensibility mechanism of the web browser 242. In some embodiments, installation of the browser extension 244 may be user-initiated, and thus the user may grant permissions or otherwise approve installation of the browser extension 244. In some embodiments, the browser extension 244 may be downloaded from the offer platform server 102 or another web server.

In block 404, the seller computing device 106 interacts with the online shopping marketplace server 108. The interaction may be performed by the web browser 242, for example by performing one or more page loads or other web requests to the marketplace server 108. In some embodiments, in block 406 the seller computing device 106 may list a product for sale with the marketplace sever 108.

In block 408, the seller computing device 106 monitors the user interactions with the marketplace server 108 using the browser extension 244. The browser extension 244 may use any technique to monitor user selections, requests, or other interactions with the marketplace server 108. The browser extension 244 may, for example, parse the current uniform resource locator (URL) being accessed by the web browser 242 or otherwise monitor operations of the web browser 242. In some embodiments, in block 410 the browser extension 244 may identify the product listed for sale, for example by extracting a product identifier.

In block 412, the seller computing device 106 creates an offer for the listed product. The offer is associated with the offered product and an offer value, may be embodied as a discount offer, a rebate offer, or other offer provided by the seller of the associated product. In some embodiments, in block 414 the seller computing device 106 may automatically create the offer in response to monitoring the user interaction. The seller computing device 106 may configure one or more parameters of the offer, for example by receiving one or more selections from a user using the browser extension 244. In block 416, the seller computing device 106 selects a product catalog for the listed product. In block 418, the seller computing device 106 selects an offer value range or amount. The offer value may be a discount amount, a rebate amount, or other offer value, which may be expressed as a monetary value, a percentage, or other value. Additionally, the offer value may be expressed a range of potential values. In block 420, the seller computing device 106 selects a total number of offers. In some embodiments, the browser extension 244 may present a recommended offer value and/or total number of offers, which may be accepted or modified by the user of the seller computing device 106. The recommended offer value and total number of offers may be determined by the offer platform server 102 based on historical performance of other offers and/or other domain knowledge of the offer platform server 102.

In block 422, the seller computing device 106 configures dynamic parameters of the offer. Dynamic parameters may be used by the offer platform server 102 to match the offer and/or determine the offer value dynamically based on monitored user interactions, user profile information, or other data. The seller computing device 106 may configure the dynamic parameters, for example, by receiving one or more selections form a user using the browser extension 244. In some embodiments, in block 424 the seller computing device 106 may associate the offer and/or offer value with one or more search keywords. The seller computing device 106 may associate offer values with particular, specific keywords. For example, low-volume keywords (i.e., keywords that appear in relatively fewer searches) may be associated with lower offer values as compared to high-volume keywords (i.e., keywords that appear in relatively many searches). In some embodiments, in block 426 the seller computing device 106 may associate the offer with one or more related products. In some embodiments, in block 424 the seller computing device 106 may associate the offer with one or more buyer tiers. For example, the seller computing device 106 may assign larger offer values to higher buyer tiers. After configuring the dynamic parameters of the offer, the method 400 loops back to block 404 to continue monitoring user interactions and creating offers.

Referring now to FIG. 5, in use, the offer platform server 102 may execute a method 500 for managing targeted offers. It should be appreciated that, in some embodiments, the operations of the method 500 may be performed by one or more components of the environment 200 of the offer platform server 102 as shown in FIG. 2. The method 500 begins with block 502, in which the offer platform server 102 creates an offer for a product listed with the marketplace server 108. As described above, the offer may be created in response to a request from a seller computing device 106. The offer is associated with an offered product listed with the marketplace server 108 and an offer value, and may be embodied as a discount offer, a rebate offer, or other offer provided by the seller of the associated product.

In block 504, the offer platform server 102 configures dynamic parameters of the offer. As described above, dynamic parameters may be used by the offer platform server 102 to match the offer and/or determine the offer value dynamically based on monitored user interactions, user profile information, or other data. Dynamic parameters may include, for example, one or more search keywords, related products, or buyer tiers associated with the offer.

In block 506, the offer platform server 102 receives a monitored user interaction from a buyer computing device 104. The offer platform server 102 may, for example, receive interaction data indicative of the user interaction from the buyer computing device 104. As described above, the interaction data may be generated by the browser extension 224 monitoring interactions of the web browser 222 with the marketplace server 108. In some embodiments, in block 508 the offer platform server 102 may receive one or more search keywords. In some embodiments, in block 510 the offer platform server 102 may receive a product identifier. In some embodiments, in block 512 the offer platform server 102 may receive an order identifier.

In block 514, the offer platform server 102 matches one or more offers based on the monitored user interaction received from the buyer computing device 104. The offer platform server 102 may, for example, match the user interaction data against one or more dynamic parameters associated with the offers. In some embodiments, in block 516 the offer platform server 102 may match one or more search keywords received from the buyer computing device 104 against keywords associated with offers. In some embodiments, in block 518 the offer platform server 102 may match a product identifier received from the buyer computing device 104 against related products associated with offers. In some embodiments, in block 520 the offer platform server 102 may match a buyer tier associated with the buyer computing device 104 against buyer tiers associated with offers.

In block 522, the offer platform server 102 sends the matching offers to the buyer computing device 104. As described above, the buyer computing device 104 presents the received offers to the user, for example using the browser extension 224 and/or the web browser 222. As described above, the user of the buyer computing device 104 may select one or more of the presented offers.

In block 524, the offer platform server 102 applies a selected offer to an order. The offer platform server 102 may receive a selection of the selected offer from the buyer computing device 104, for example from the browser extension 224. The offer platform server 102 may apply the offer using any appropriate technique based on the type of offer and/or the offer value. In some embodiments, in block 526 the offer platform server 102 may generate a discount code for the marketplace server 108. The discount code may be provided to the buyer computing device 104, for example using the browser extension 224. In some embodiments, in block 528 the offer platform server 102 may initiate an automatic rebate process. One potential embodiment of the automatic rebate process is described below in connection with FIG. 6.

In block 530, the offer platform server 102 updates a buyer profile based on the applied offer. The buyer profile may include any appropriate data associated with the user of the buyer computing device 104, including purchase history, demographic data, or other data. The buyer profile may associate the buyer with one or more tiers that each may be associated with particular offers or offer values. For example, buyers with higher tiers may be provided offers with relatively higher offer values. In some embodiments, in block 532 the offer platform server 102 may increase a buyer tier associated with the buyer computing device 104 based on the completed purchase. Thus, as the number and/or value of purchases completed by the buyer computing device 104 increase, the associated buyer tier may also increase. In some embodiments, in block 534 the offer platform server 102 may increase a buyer tier based on a successful referral of another buyer. For example, a user may send referral invitations to other potential users using one or more social media platforms.

Similarly, in block 536, the offer platform server 102 updates a seller profile based on the applied offer. For example, the offer platform server 102 may update the total number of applied offers, total offer value, or other seller information. As another example, the offer platform server 102 may rate sellers based upon authenticity and quality of products that are sold. In block 538, the offer platform server 102 may provide analytics to the seller computing device 106. Analytics provided to the seller computing device 106 may include information on the number of matching buyers, the number of offers presented, the number of offers selected, and other information related to performance of the offer campaign. After providing analytics, the method 500 loops back to block 506, in which the offer platform server 102 may receive additional user interaction data and match additional offers.

Referring now to FIG. 6, in use, the offer platform server 102 may execute a method 600 for automatic rebate fulfillment. It should be appreciated that, in some embodiments, the operations of the method 600 may be performed by one or more components of the environment 200 of the offer platform server 102 as shown in FIG. 2. The method 600 begins with block 602, in which the offer platform server 102 receives a selected rebate offer from a buyer computing device 104. The selected offer may be received as part of the dynamic offer presentation process described above in connection with FIG. 5. In some embodiments, in block 604 the offer platform server 102 may determine an order identifier associated with the selected rebate offer. The order identifier identifies the particular order or other purchase made by the buyer computing device 104 with the marketplace server 108. The order identifier may be determined automatically, for example by being extracted from a URL by the browser extension 224, or in some embodiments may be input by a user.

In block 606, the offer platform server 102 monitors the order identifier with the marketplace server 108. For example, the offer platform server 102 may query the marketplace server 108 to determine whether the specified order includes the product associated with the selected order, to determine whether the order has been successfully paid for, to determine whether the product has been returned, or to determine other information regarding the status of the order. As compared to a percentage discount, the marketplace server 108 may process the order as a full-price purchase. Additionally, the marketplace server 108 may recognize that the order was made by an authentic person (i.e., not an automated script or other “bot”). Thus, successfully completing the order may increase search results ranking with the marketplace server 108 for the related product, increase seller ranking with the marketplace server 108, increase likelihood of recommendation of the related product by the marketplace server 108, or otherwise improve placement of the related product in search results provided by the marketplace server 108.

In block 608, the offer platform server 102 determines whether the order is valid. The offer platform server 102 may use multiple criteria for validity. For example, the offer platform server 102 may determine whether the product associated with the offer was successfully purchased and whether a predetermined time period has elapsed without the product being returned. If the order is not valid, the method 600 loops back to block 606 to continue monitoring the order identifier. If the order is valid, the method 600 proceeds to block 610.

In block 610, the offer platform server 102 applies the selected rebate offer. The offer platform server 102 may use any technique to apply the selected rebate. In some embodiments, in block 612 the offer platform server 102 may transfer the rebate amount to a buyer account from a seller account. The accounts may include electronic money transfer accounts or other deposit accounts, and may be maintained by a third party server or other institution. After applying the rebate offer, the method 600 is completed. The method 600 may be executed again to apply additional rebates.

Referring now to FIG. 7, diagram 700 illustrates one potential embodiment of a user interface of the buyer computing device 104. The diagram 700 illustrates the web browser 222 that is accessing a product search function of the marketplace server 108. The web browser 222 includes user interface controls 702 and a content area 704. The user interface controls 702 may include various toolbar buttons and other user interface elements that allow the user to control navigation of the web browser 222. Illustratively, the user interface controls 702 include an address bar 706, which allows the user to enter a URL into the browser 222 and may display the URL of the web page currently being viewed. The user interface controls 702 also include a tool bar button 708 that allows access to the browser extension 224.

The content area 704 includes a search terms field 710 and filter controls 712. The search terms field 710 and the filter controls 712 allow the user to search and/or browse for products offered for sale by the marketplace server 108. Selections made by the user in the search terms field 710 and/or the filter controls 712 may change the URL of the active web page, which may be reflected in the address bar 706 or in programmatic interfaces provided by the web browser 222. The content area 704 further includes a search results area 712, which includes multiple search results 714. Each search result 714 may include product information and may be hyperlinked to a detail view of the corresponding product. The search results area 712 may not show all products that match the active search terms and/or search filter settings. For example, the search results area may be paginated, scrollable, or otherwise display only a part of all matching search results.

Referring now to FIG. 8, diagram 800 illustrates one potential embodiment of a notification 802 of a matching offer that may be presented by the browser extension 224. As shown in FIG. 8, the notification 802 may be displayed within the content area 704 of the web browser 222. Additionally or alternatively, in some embodiments the notification 802 may be displayed within the user interface controls 702 or another part of the web browser 222. The notification 802 may include product information, offer value, or other offer information related to a matching offer. In particular, the notification 802 may present an offer that is related to a product that is not currently visible in the search results area 712. For example, the offer may be related to a product shown in a subsequent page of search results or in an offscreen part of a scrollable view. In some embodiments, the notification 802 may include a clickable link or other user interface control, for example to allow the user to accept the offer, to view additional offer details, or to provide other features.

Referring now to FIG. 9, diagram 900 illustrates one potential embodiment of a notification 902 of a matching offer that may be presented by the browser extension 224. Similar to the notification 802, the notification 902 may be displayed within the content area 704 of the web browser 222. The illustrative notification 902 displays offer information 904 for offers that are associated with one or more products shown in the search results area 712. The browser extension 224 also generates a highlight 906 within the content area 704. The highlight 906 visually emphasizes a search result 714 correspond to a matching offer 904 shown in the notification 902. Although illustrated as including a single matching offer 904 and corresponding highlight 906, it should be understood that in some embodiments the browser extension 224 may present multiple matching offers 904 and/or corresponding highlights 906. Similar to the notification 802, the notification 902 and/or the highlight 906 may include a clickable link or other user interface control, for example to allow the user to accept the offer, to view additional offer details, or to provide other features.

Referring now to FIG. 10, diagram 1000 illustrates one potential embodiment of a shopping cart user interface that may be presented by the buyer computing device 104. As shown, the content area 704 of the web browser 222 includes a shopping cart view 1002, including multiple shopping cart entries 1004. The shopping cart view 1002 is provided by the marketplace server 108, and each of the shopping cart entries 1004 represents a product that has been purchased or will be purchased by the user. The diagram 1000 also illustrates a notification 1006 that may be presented by the browser extension 224. Similar to the notifications 802, 902, the notification 1006 may be displayed within the content area 704 of the web browser 222. The notification 1006 includes offer information 1008 for offers matching one or more products in the user's shopping cart (e.g., matching one or more shopping cart entries). In particular, each offer presented in the notification 1006 may be for a related product associated with one or more products in the user's shopping cart. The notification 1006 may include one or more clickable links or other user interface controls, for example to allow the user to accept an offer, to view additional offer details, or to provide other features.

Additionally or alternatively, as described above in connection with block 332 of FIG. 3, in some embodiments, the offer platform server 102 may also provide a standalone website that presents a catalog, a directory, a portal, or other listing of offers available on the offer platform sever 102. The web browser 222 and/or the browser extensions 224 may access this website provided by the offer platform server 102 to browse, search, or otherwise access all offers available on the offer platform server 102. The user interface of the offer platform server 102 may be similar to the content area 704 shown in FIG. 7, including a search results area 712 including multiple search results 714 that each correspond to an offer available on the offer platform server 102. In those embodiments, the catalog of available offers may be presented without additional user interactions with the marketplace server 108.

1. A computing device comprising:
a browser extension associated with a web browser of the computing device;
a user interaction manager to (i) monitor, by the browser extension, a user interaction with a marketplace server by the web browser and (ii) determine, by the browser extension, interaction data indicative of the user interaction in response to monitoring of the user interaction; and
an offer platform interface to (i) send, by the browser extension, the interaction data to an offer platform server in response to the monitoring of the user interaction and (ii) receive, by the browser extension, offer data from the offer platform server in response to sending of the interaction data, wherein the offer data is indicative of an offered product and an offer value;
wherein the user interaction manager is further to present, by the browser extension, an offer based on the offer data with the web browser.

2. The computing device of claim 1, wherein to monitor the user interaction comprises to parse a uniform resource locator associated with the user interaction, wherein the uniform resource locator is provided by the web browser.

3. The computing device of claim 1, wherein to monitor the user interaction comprises to identify a keyword search.

4. The computing device of claim 1, wherein to monitor the user interaction comprises to identify a product details view.

5. The computing device of claim 1, wherein to monitor the user interaction comprises to identify a shopping cart check out.

6. The computing device of claim 1, wherein to present the offer comprises to display a notification in a content area of the web browser.

7. The computing device of claim 1, wherein to present the offer comprises to highlight a search result corresponding to the offered product of the offer in a search results page presented by the web browser.

8. The computing device of claim 1, wherein to present the offer comprises to display product information corresponding to the offered product of the offer in a content area of the web browser.

9. A method comprising:
monitoring, by a browser extension of a computing device, a user interaction with a marketplace server by a web browser of the computing device;
determining, by the browser extension, interaction data indicative of the user interaction in response to monitoring the user interaction;
sending, by the browser extension, the interaction data to an offer platform server in response to monitoring the user interaction;
receiving, by the browser extension, offer data from the offer platform server in response to sending the interaction data, wherein the offer data is indicative of an offered product and an offer value; and
presenting, by the browser extension, an offer based on the offer data with the web browser.

10. The method of claim 9, wherein monitoring the user interaction comprises parsing a uniform resource locator associated with the user interaction, wherein the uniform resource locator is provided by the web browser.

11. The method of claim 9, wherein presenting the offer comprises highlighting a search result corresponding to the offered product of the offer in a search results page presented by the web browser.

12. The method of claim 9, wherein presenting the offer comprises displaying product information corresponding to the offered product of the offer in a content area of the web browser.

13. A computing device comprising:
a buyer interface to receive interaction data indicative of a user interaction with a marketplace server from a buyer computing device; and
an offer manager to match the interaction data with an offer selected from a plurality of offers stored by the computing device, wherein each offer is indicative of an offered product and an offer value;
wherein the buyer interface is further to send offer data indicative of the offer to the buyer computing device in response to a match of the interaction data with the offer.

14. The computing device of claim 13, wherein:
to receive the interaction data comprises to receive a search keyword; and
to match the interaction data with the offer comprises to match the search keyword with a keyword associated with the offer.

15. The computing device of claim 13, wherein:
to receive the interaction data comprises receiving a product identifier; and
to match the interaction data with the offer comprises to match the product identifier with a related product associated with the offer.

16. The computing device of claim 13, wherein to match the interaction data with the offer comprises to match a buyer tier associated with the buyer computing device with a buyer tier associated with the offer, wherein to match the buyer tier comprises to determine the offer value based on the buyer tier.

17. The computing device of claim 13, wherein:
to receive the interaction data comprises to receive an order identifier; and
to match the interaction data with the offer comprises to match a product associated with the order identifier with a related product associated with the offer.

18. The computing device of claim 13, wherein:
the buyer interface is further to receive a selection of the offer from the buyer computing device in response to sending of the offer data; and
the offer manager is further to apply the offer to an order in response to receipt of the selection.

19. The computing device of claim 18, wherein to apply the offer comprises to generate a discount code for a marketplace server.

20. The computing device of claim 18, wherein to apply the offer comprises to perform a rebate process, wherein to perform the rebate process comprises to:
determine an order identifier associated with the order;
monitor the order identifier with a marketplace server;
determine whether the order is valid in response to monitoring of the order identifier; and
apply the offer value of the offer in response to a determination that the order is valid.
